(19) United States
(12) Patent Application Publication
(10) Pub. No.: US 2013/0005619 A1
(43) Pub. Date: Jan. 3, 2013

(54) LUBRICATING OIL COMPOSITION FOR REDUCING FRICTION COMPRISING NANOPOROUS PARTICLES

(75) Inventors: Hyeung Jin Lee, Seoul (KR); Yong Rae Cho, Daejeon (KR)

(73) Assignee: SK LUBRICANTS CO., LTD., Seoul (KR)

(21) Appl. No.: 13/583,084

(22) PCT Filed: Mar. 16, 2011
(86) PCT No.: PCT/KR2011/001839

§ 371 Date: Sep. 6, 2012

(30) Foreign Application Priority Data
Mar. 26, 2010 (KR) 10-2010-0027376

(51) Int. Cl. C10M 125/02; C10M 125/10; C10M 125/22; C10M 125/30; C10M 125/26; C10M 125/04; B82Y 30/00

(52) U.S. Cl. 508/113; 508/136; 508/165; 508/172; 508/154; 508/150; 508/167; 508/155; 977/742

(57) ABSTRACT

The present invention provides a lubricating oil composition for reducing a friction coefficient adjacent to the surface of being subjected to lubrication. In particular, the present invention provides nanoporous particles capable of being dispersed in a lubricating oil composition comprising base oil having a lubricant viscosity. Since the nanoporous particles having nano-sized, oil soluble pores according to the present invention reduces a friction coefficient, and in the long term, gradually releases an effective ingredient, the lubricating oil composition comprising the same of the present invention can act as a reducing agent for reducing friction for a long period of time, and thereby, exhibit excellent lubricant effects.

### TECHNICAL FIELD

The present invention relates to a lubricating oil composition comprising nanoporous particles which can reduce friction, and thereby, improve energy efficiency or fuel efficiency.

### BACKGROUND ART

There are several types of lubricants such as a liquid lubricant, a paste lubricant and a solid lubricant comprising a liquid lubricant, and among them, the solid lubricant has been widely used. Lubricants can be used in automobile engines, transmissions, bearings, industrial gears and other machines so as to reduce friction and abrasion and improve energy efficiency or fuel efficiency.

Generally, a lubricant composition comprises a dispersing agent, a cleaner, a friction reducing agent, an anti-abrasion agent, an antioxidant and a corrosion inhibitor, but is not limited thereto, numerous other ingredients can be added as well. Further, in most lubrication processes, viscosity index improvers or friction reducers can be added as an important ingredient.

Recently, as energy resource becomes exhausted and strict environmental regulations becomes established, there is an increasing need to enhance fuel efficiency and reduce the emission of exhaust fumes. In order to increase fuel efficiency, organic friction reducers are commonly added to lubricants. However, the improvement of fuel efficiency caused by the addition of organic friction reducers is very restricted. Therefore, there has been a need for the development of a new method for further improving fuel efficiency.

Another method for improving fuel efficiency is to use a lubricant having a lower viscosity grade. Although the use of a lubricant having a lower viscosity grade can improve fuel efficiency, such a use may cause the increase in friction. It is possible to partially reduce friction by using anti-abrasion agents such as ZDTP (zinc dialkyl-dithiophosphate). However, ZDTP contains a phosphate, it can affect adversely automotive catalyst systems for exhaust control, and thus, it is preferable to do not use it.

### DISCLOSURE

### Technical Problem

Considering the aforementioned situations, there is an urgent need to develop a method for improving fuel efficiency through the enhancement of friction and abrasion reduction effects and using an apparatus stably for a long period of time without a negative effect on an exhaust control system.

### Technical Solution

The present invention provides a lubricating oil composition comprising a lubricant and nanoporous particles.

### Advantageous Effects

Since the nanoporous particles having nano-sized, oil soluble pores according to the present invention reduces a friction coefficient, and in the long term, gradually releases an effective ingredient, the lubricating oil composition comprising the same of the present invention can act as a reducing agent for reducing friction for a long period of time, and thereby, exhibit excellent lubricant effects.

### DESCRIPTION OF DRAWINGS

FIG. 1 is a photograph of silver nanoporous silicon particles taken with an electron microscope.

### BEST MODE

The present invention relates to a lubricating oil composition comprising a lubricant and nanoporous particles.

The lubricating oil composition generally comprises a dispersing agent, a cleaner, a friction reducing agent, an anti-abrasion agent, an antioxidant and a corrosion inhibitor, but are not limited thereto, numerous other ingredients can be added. Further, in most lubrication process, viscosity index improvers or friction reducers can be used as an important ingredient. The present invention provides a lubricant comprising high functional nanoporous particles capable of reducing friction and lessening abrasion. Since the nanoporous particles having a nano-sized, oil soluble pore can reduce a friction coefficient and gradually release an effective ingredient in the long run, the lubricating oil composition comprising the same of the present invention acts as a reducing agent of reducing friction continuously.

Preferably, the present invention relates to a lubricating oil composition which is characterized in that the nanoporous particles are selected from the group consisting of silica, titanium dioxide, alumina, tin dioxide, magnesium oxide, cerium oxide, zirconia, clay, kaolin, ceria, talc, mica, molybdenum, tungsten, tungsten disulfide, graphite, carbon nanotube, silicon nitride, boron nitride and mixtures thereof.

There is no limitation to the kind of nanoporous particles to be used, but it is preferable to use the nanoporous particles being composed of silica, titanium dioxide, alumina or tin dioxide.

Further, the present invention relates to a lubricating oil composition wherein the nanoporous particles has an average particle size ranging from 50 nm to 5 μm and has a nano-pore size ranging from the 0.01 nm to 100 nm.

If the particle size of the nanoporous particles is less than 50 nm, it is difficult to prepare homogeneous porous particles and maintain their porous structure due to the pore size similar to the particle size. Meanwhile, if the particle size exceeds 5 μm, the nanoporous particles having such a big particle size act as impurities rather than as a friction reducing agent, leading to unfavorable effects on the reduction of friction. If the nanoporous particles have a nano-pore size of 0.01 nm or smaller, there is a problem with the decrease in oil solubility. If they have a nano-pore size of 100 nm or larger, the nanoporous particles are excessively dissolved in oil, leading to unfavorable light scattering and haze.

Preferably, the present invention relates to a lubricating oil composition which is characterized by comprising 0.01 to 3.0 parts by weight of nanoporous particles based on 100 parts by weight of the lubricant.

When the content of the nanoporous particles is lower than 0.01 parts by weight, it is too small to exert friction reducing and abrasion lessening effects. When the content thereof exceeds 3.0 parts by weight, there is a problem with the decrease in oil solubility, which results in the occurrence of haze or precipitation or insignificant effects on the reduction of friction or abrasion.

More preferably, the present invention relates to a lubricating oil composition which is characterized in the lubricant comprises base oil, antioxidants, metal cleaners, corrosion inhibitors, foam inhibitors, pour point depressants, viscosity modifiers and dispersing agents.

Hereinafter, the present invention is exemplified by a lubricating oil composition comprising nanoporous silica particles as nanoporous particles and described in detail, but is not limited thereto.

In order to prepare nanoporous silica particles, jelly type silica made from glass or quartz with a liquid solvent such as ethanol is used as a starting material. Such kind of silica gel has a colloid system where solid particles are interconnected and which is unbreakable at normal temperature and pressure.

The jelly type silica used in the present invention can be prepared by polymerizing a silicon alkoxide with water in a mixing solvent (such as ethanol). The reaction occurs by hydrolysis and water condensation, joining together the alkoxide molecules making silicon-oxygen bonds to form oligomers. The oligomers join together and form one giant molecule, which is the solid part of a gel. The silica matrix in the alkoxide gel is filled with ethanol, having tiny little pockets 0.01 to 100 nm across. These tiny pockets in the gel form nanopores, and thus obtained alkoxide particles are dried so as to form nanoporous particles.

The particles can be dried by freeze-drying or evaporation. However, in case of freeze-drying, there are problems in that the process takes several days, and it is very difficult to maintain the pore structure of fine particles due to the occurrence of particle shrinkage. The evaporating process also causes similar problems, generates disgusting vapor, and is hard to maintain uniform pore size. The yield of particles being dried while maintaining their pore structure by the freeze-drying or evaporating process is only about 10%. Therefore, in order to dry the particles while maintaining their pore size and structure, it is preferable to use a supercritical drying method. The drying method employs a supercritical fluid which is any substance at a temperature and pressure above its critical point.

Such a supercritical fluid has properties between those of a gas and a liquid (semi-gas/semi-liquid phase) and can expand like a gas, but its density and thermal conductivity are similar to a liquid. Further, since it has lower surface tension than a liquid, the use of a supercritical fluid makes it possible to dry the particles while maintaining their gel structure. Namely, the particles can be dried with heating at a temperature above its critical point gradually. At this time, the supercritical fluid released from the gel structure can be vented in a gas phase, and thus dried particles have a pore volume of 90% or higher.

Representatively, the lubricant suitable for the present invention can be a lubricant having the following composition, as listed in Table 1.

TABLE 1

| Ingredient | Broad range (wt %) | General range (wt %) |
|---|---|---|
| Base oil | Residual | Residual |
| Antioxidant | 0~5.0 | 0.01~3.0 |
| Metal cleaner | 0.1~15.0 | 0.2~8.0 |
| Corrosion inhibitors | 0~5.0 | 0~2.0 |
| Foam inhibitors | 0~5.0 | 0.001~0.15 |
| Pour point depressants | 0.01~5.0 | 0.01~1.5 |
| Viscosity modifiers | 0.01~10.0 | 0.25~7.0 |
| Dispersing agents | 0.5~5.0 | 1.0~2.5 |
| Total | 100 | 100 |

The above Table 1 shows the representatively effective amounts of additives used in the common lubricants. The amounts and kinds of additives listed in Table 1 are well-known in the art, and the scope of the present invention is not limited thereto. Further, combinations and compositions described in the following examples are for illustrative purpose only and shall not be construed as limiting the scope of the present invention.

### Mode for Invention

### Examples 1-56

### Preparation of a Lubricating Oil Composition Comprising Nanoporous Particles

Lubricants were prepared by using a lubricant combination A or B as shown in Table 2. The nanoporous particles were prepared by converting silicon alkoxide into a gel type and drying the same by using a supercritical fluid such as carbon dioxide. Next, thus prepared nanoporous particles were added in the amount of Table 3 based on 100 parts by weight of the lubricant, to thereby prepare lubricating oil compositions of Examples 1 to 56.

Representatively, nano porous silica was prepared as follows. First, 50 ml of TEOS (tetraethyl ortho silicate) were mixed with 40 ml of ethanol, followed by successively adding 35 ml of ethanol, 70 ml of water, 0.275 ml of a 30% ammonia solution, and 0.2 ml of 0.5 M ammonium fluoride thereto. Here, ammonia and ammonium fluoride act as a catalyst. The resulting solution was completely mixed with gentle stirring so as to induce gelation, to thereby form an alkoxide gel. The gelation was conducted for 2 hours. After the gelation was completed, the alkoxide gel was put into an autoclave. Carbon dioxide (CO₂) was injected into the autoclave, and the temperature and pressure of the autoclave were set to above the critical point for CO₂(31° C. and 72.4 atm). The alkoxide gel was slowly released from the autoclave for 12 hours. Through this process, the released particles were dried while maintaining their nanoporous structure, to thereby obtain silica aerogel (pore size: 20 nm, diameter: 400 nm).

According to the method as described above, nanoporous titanium dioxide particles (pore size: 30 nm, diameter: 500 nm) prepared by using titanium alkoxide and alcohol supercritical fluid; nanoporous alumina particles (pore size: 25 nm, diameter: 100 nm) prepared by forming aluminum alkoxide, converting it to a gel type and drying it with carbon dioxide supercritical fluid; and nanoporous tin dioxide particles (pore size: 40 nm, diameter: 180 nm) preparedS by forming tin alkoxide, converting it to a gel type and drying it with alcohol supercritical fluid were obtained. Thus obtained nanoporous particles were added to a lubricant according to the composition rate of Table 3, to thereby prepare lubricating oil compositions.

TABLE 2

| | Lubricant composition (wt %) | |
|---|---|---|
| Ingredient | Combination A | Combination B |
| Base oil (mineral oil) | 90.9 | 84.45 |
| Antioxidant (polyol ester) | 1.5 | 2.0 |
| Metal cleaner (calcium phosphate) | 0.5 | 1.5 |
| Corrosion inhibitor (alkyl succinate) | 0.5 | 1.0 |
| Foam inhibitor (dimethyl siloxane) | 0.1 | 0.05 |
| Pour point depressant (polyalkyl | 0.5 | 1.0 |
| methacrylate) | | |
| Viscosity modifier (polymethacrylate) | 5 | 8 |
| Dispersing agent (polyisobutenyl | 1 | 2 |
| succinimide) | | |
| Total | 100 | 100 |

TABLE 3

| | | Nanoporous particles (parts by weight) | | | |
|---|---|---|---|---|---|
| | | | Titanium | | Tin |
| | | Silica | dioxide | Alumina | dioxide |
| | | (pore: | (pore: | (pore: | (pore: |
| | | 20 nm, | 30 nm, | 25 nm, | 40 nm, |
| Ex- | | diameter: | diameter: | diameter: | diameter: |
| ample | Lubricant | 400 nm) | 500 nm) | 100 nm) | 180 nm) |
| Ex. 1 | Combination A | 0.05 | | | |
| Ex. 2 | Combination A | 0.1 | | | |
| Ex. 3 | Combination A | 0.3 | | | |
| Ex. 4 | Combination A | 0.5 | | | |
| Ex. 5 | Combination A | 1.0 | | | |
| Ex. 6 | Combination A | 1.5 | | | |
| Ex. 7 | Combination A | 2.5 | | | |
| Ex. 8 | Combination B | 0.02 | | | |
| Ex. 9 | Combination B | 0.1 | | | |
| Ex. 10 | Combination B | 0.3 | | | |
| Ex. 11 | Combination B | 0.5 | | | |
| Ex. 12 | Combination B | 1.0 | | | |
| Ex. 13 | Combination B | 1.5 | | | |
| Ex. 14 | Combination B | 2.5 | | | |
| Ex. 15 | Combination A | | 0.05 | | |
| Ex. 16 | Combination A | | 0.1 | | |
| Ex. 17 | Combination A | | 0.3 | | |
| Ex. 18 | Combination A | | 0.5 | | |
| Ex. 19 | Combination A | | 1.0 | | |
| Ex. 20 | Combination A | | 1.5 | | |
| Ex. 21 | Combination A | | 2.5 | | |
| Ex. 22 | Combination B | | 0.05 | | |
| Ex. 23 | Combination B | | 0.1 | | |
| Ex. 24 | Combination B | | 0.3 | | |
| Ex. 25 | Combination B | | 0.5 | | |
| Ex. 26 | Combination B | | 1.0 | | |
| Ex. 27 | Combination B | | 1.5 | | |
| Ex. 28 | Combination B | | 2.5 | | |
| Ex. 29 | Combination A | | | 0.05 | |
| Ex. 30 | Combination A | | | 0.1 | |
| Ex. 31 | Combination A | | | 0.3 | |
| Ex. 32 | Combination A | | | 0.5 | |
| Ex. 33 | Combination A | | | 1.0 | |
| Ex. 34 | Combination A | | | 1.5 | |
| Ex. 35 | Combination A | | | 2.5 | |
| Ex. 36 | Combination B | | | 0.01 | |
| Ex. 37 | Combination B | | | 0.1 | |
| Ex. 38 | Combination B | | | 0.3 | |
| Ex. 39 | Combination B | | | 0.5 | |
| Ex. 40 | Combination B | | | 1.0 | |
| Ex. 41 | Combination B | | | 1.5 | |
| Ex. 42 | Combination B | | | 2.5 | |
| Ex. 43 | Combination A | | | | 0.05 |
| Ex. 44 | Combination A | | | | 0.1 |
| Ex. 45 | Combination A | | | | 0.3 |
| Ex. 46 | Combination A | | | | 0.5 |
| Ex. 47 | Combination A | | | | 1.0 |
| Ex. 48 | Combination A | | | | 1.5 |
| Ex. 49 | Combination A | | | | 2.5 |
| Ex. 50 | Combination B | | | | 0.05 |
| Ex. 51 | Combination B | | | | 0.1 |
| Ex. 52 | Combination B | | | | 0.3 |
| Ex. 53 | Combination B | | | | 0.5 |
| Ex. 54 | Combination B | | | | 1.0 |
| Ex. 55 | Combination B | | | | 1.5 |
| Ex. 56 | Combination B | | | | 2.5 |

### Comparative Examples 1-37

### Preparation of a Lubricating Oil Composition Comprising Nanoporous Particles Having Similar Physical Properties to Those of Examples

Lubricants were prepared by using a lubricant combination A or B as shown in Table 2. The nanoporous particles were prepared by converting silicon alkoxide into a gel type and drying the same by using a supercritical fluid such as carbon dioxide. Next, thus prepared nanoporous particles were added in the amount of Table 4 based on 100 parts by weight of the lubricant, to thereby prepare lubricating oil compositions of Comparative Examples 1 to 37.

Representatively, nano porous silica was prepared as follows. First, 50 ml of TEOS (tetraethyl ortho silicate) were mixed with 40 ml of ethanol, followed by successively adding 35 ml of ethanol, 70 ml of water, 0.275 ml of a 30% ammonia solution, and 0.2 ml of 0.5 M ammonium fluoride thereto. Here, ammonia and ammonium fluoride act as a catalyst. The resulting solution was completely mixed with gentle stirring so as to induce gelation, to thereby form an alkoxide gel. The gelation was conducted for 2 hours. After the gelation was completed, the alkoxide gel was put into an autoclave. Carbon dioxide (CO₂) was injected into the autoclave, and the temperature and pressure of the autoclave were set to above the critical point for CO₂ (31° C. and 72.4 atm). The alkoxide gel was slowly released from the autoclave for 12 hours. Through this process, the released particles were dried while maintaining their nanoporous structure, to thereby obtain silica aerogel (pore size: 20 nm, diameter: 400 nm).

According to the method as described above, nanoporous titanium dioxide particles (pore size: 30 nm, diameter: 500 nm) prepared by using titanium alkoxide and alcohol supercritical fluid; nanoporous alumina particles (pore size: 25 nm, diameter: 100 nm) prepared by forming aluminum alkoxide, converting it to a gel type and drying it with carbon dioxide supercritical fluid; and nanoporous tin dioxide particles (pore size: 40 nm, diameter: 180 nm) prepared by forming tin alkoxide, converting it to a gel type and drying it with alcohol supercritical fluid were obtained. Thus obtained nanoporous particles were added to a lubricant according to the composition rate of Table 4, to thereby prepare lubricating oil compositions.

TABLE 4

| | | Nanoporous particles (parts by weight) | | | |
|---|---|---|---|---|---|
| | | | Titanium | | Tin |
| | | Silica | dioxide | Alumina | dioxide |
| Compa- | | (pore: | (pore: | (pore: | (pore: |
| rative | | 20 nm, | 30 nm, | 25 nm, | 40 nm, |
| Ex- | | diameter: | diameter: | diameter: | diameter: |
| ample | Lubricant | 400 nm) | 500 nm) | 100 nm) | 180 nm) |
| Comp. | Combination A | 0.00 | 0.00 | 0.00 | 0.00 |
| Ex. 1 | | | | | |
| Comp. | Combination B | 0.00 | 0.00 | 0.00 | 0.00 |
| Ex 2 | | | | | |
| Comp. | Combination A | 0.005 | | | |
| Ex. 3 | | | | | |
| Comp. | Combination A | 3.5 | | | |
| Ex. 4 | | | | | |
| Comp. | Combination A | 5 | | | |
| Ex. 5 | | | | | |
| Comp. | Combination B | 0.005 | | | |
| Ex. 6 | | | | | |
| Comp. | Combination B | 3.5 | | | |
| Ex. 7 | | | | | |
| Comp. | Combination B | 5.0 | | | |
| Ex. 8 | | | | | |
| Comp. | Combination A | | 0.005 | | |
| Ex. 9 | | | | | |
| Comp. | Combination A | | 3.5 | | |
| Ex. 10 | | | | | |
| Comp. | Combination A | | 5.0 | | |
| Ex. 11 | | | | | |
| Comp. | Combination B | | 0.005 | | |
| Ex. 12 | | | | | |
| Comp. | Combination B | | 3.5 | | |
| Ex. 13 | | | | | |
| Comp. | Combination A | | 5.0 | | |
| Ex. 14 | | | | | |
| Comp. | Combination A | | | 0.005 | |
| Ex. 15 | | | | | |
| Comp. | Combination A | | | 3.5 | |
| Ex. 16 | | | | | |
| Comp. | Combination A | | | 5.0 | |
| Ex. 17 | | | | | |
| Comp. | Combination B | | | 0.005 | |
| Ex. 18 | | | | | |
| Comp. | Combination B | | | 3.5 | |
| Ex. 19 | | | | | |
| Comp. | Combination B | | | 5.0 | |
| Ex. 20 | | | | | |
| Comp. | Combination A | | | | 0.005 |
| Ex. 21 | | | | | |
| Comp. | Combination A | | | | 3.5 |
| Ex. 22 | | | | | |
| Comp. | Combination A | | | | 5.0 |
| Ex. 23 | | | | | |
| Comp. | Combination B | | | | 0.005 |
| Ex. 24 | | | | | |
| Comp. | Combination B | | | | 3.5 |
| Ex. 25 | | | | | |
| Comp. | Combination B | | | | 5.0 |
| Ex. 26 | | | | | |
| Comp. | Combination A | 0.002 | 0.003 | | |
| Ex. 27 | | | | | |
| Comp. | Combination A | | 0.003 | 0.002 | |
| Ex. 28 | | | | | |
| Comp. | Combination A | | | 0.003 | 0.002 |
| Ex. 29 | | | | | |
| Comp. | Combination A | 0.003 | | | 0.002 |
| Ex. 30 | | | | | |
| Comp. | Combination A | 0.001 | 0.001 | 0.001 | 0.001 |
| Ex. 31 | | | | | |
| Comp. | Combination B | 0.001 | 0.001 | 0.001 | 0.001 |
| Ex. 32 | | | | | |
| Comp. | Combination B | 0.002 | 0.003 | | |
| Ex. 33 | | | | | |
| Comp. | Combination B | | 0.003 | 0.002 | |
| Ex. 34 | | | | | |
| Comp. | Combination B | | | 0.003 | 0.002 |
| Ex. 35 | | | | | |
| Comp. | Combination B | 0.003 | | | 0.002 |
| Ex. 36 | | | | | |
| Comp. | Combination B | 0.001 | 0.001 | 0.001 | 0.001 |
| Ex. 37 | | | | | |

### Comparative Examples 38-400

### Preparation of a Lubricating Oil Composition Comprising Nanoporous Particles Having Different Physical Properties from Those of Examples

Lubricants were prepared by using a lubricant combination A or B as shown in Table 2. The nanoporous particles were prepared by converting silicon alkoxide into a gel type and drying the same by using a supercritical fluid such as carbon dioxide. Next, thus prepared nanoporous particles were added in the amount of Table 5 based on 100 parts by weight of the lubricant, to thereby prepare lubricating oil compositions of Comparative Examples 38 to 100.

Representatively, nano porous silica was prepared as follows. First, 50 ml of TEOS (tetraethyl ortho silicate) were mixed with 40 ml of ethanol, followed by successively adding 35 ml of ethanol, 70 ml of water, 0.275 ml of a 30% ammonia solution, and 0.2 ml of 0.5 M ammonium fluoride thereto. Here, ammonia and ammonium fluoride act as a catalyst. The resulting solution was completely mixed with gentle stirring so as to induce gelation, to thereby form an alkoxide gel. The gelation was conducted for 1 hour. After the gelation was completed, the alkoxide gel was put into an autoclave. Carbon dioxide (CO₂) was injected into the autoclave, and the temperature and pressure of the autoclave were set to above the critical point for CO₂ (31° C. and 72.4 atm). The alkoxide gel was slowly released from the autoclave for 6 hours. Through this process, the released particles were dried while maintaining their nanoporous structure, to thereby obtain silica aerogel (pore size: 400 nm, diameter: 600 nm).

According to the method as described above, nanoporous titanium dioxide particles (pore size: 200 nm, diameter: 800 nm) prepared by using titanium alkoxide and alcohol supercritical fluid; nanoporous alumina particles (pore size: 250 nm, diameter: 650 nm) prepared by forming aluminum alkoxide, converting it to a gel type and drying it with carbon dioxide supercritical fluid; and nanoporous tin dioxide particles (pore size: 300 nm, diameter: 700 nm) prepared by forming tin alkoxide, converting it to a gel type and drying it with alcohol supercritical fluid were obtained. Thus obtained nanoporous particles were added to a lubricant according to the composition rate of Table 5, to thereby prepare lubricating oil compositions.

TABLE 5

| | | Nanoporous particles (parts by weight) | | | |
|---|---|---|---|---|---|
| | | | Titanium | | Tin |
| | | Silica | dioxide | Alumina | dioxide |
| Compa- | | (pore: | (pore: | (pore: | (pore: |
| rative | | 400 nm, | 200 nm, | 250 nm, | 300 nm, |
| Ex- | | diameter: | diameter: | diameter: | diameter: |
| ample | Lubricant | 600 nm) | 800 nm) | 650 nm) | 700 nm) |
| Comp. | Combination A | 0.005 | | | |
| Ex. 38 | | | | | |
| Comp. | Combination A | 0.1 | | | |
| Ex. 39 | | | | | |
| Comp. | Combination A | 0.3 | | | |
| Ex. 40 | | | | | |
| Comp. | Combination A | 0.5 | | | |
| Ex. 41 | | | | | |
| Comp. | Combination A | 1.0 | | | |
| Ex. 42 | | | | | |
| Comp. | Combination A | 1.5 | | | |
| Ex. 43 | | | | | |
| Comp. | Combination A | 2.5 | | | |
| Ex. 44 | | | | | |
| Comp. | Combination B | 0.05 | | | |
| Ex. 45 | | | | | |
| Comp. | Combination B | 0.1 | | | |
| Ex. 46 | | | | | |
| Comp. | Combination B | 0.3 | | | |
| Ex. 47 | | | | | |
| Comp. | Combination B | 0.5 | | | |
| Ex. 48 | | | | | |
| Comp. | Combination B | 1.0 | | | |
| Ex. 49 | | | | | |
| Comp. | Combination B | 1.5 | | | |
| Ex. 50 | | | | | |
| Comp. | Combination B | 2.5 | | | |
| Ex. 51 | | | | | |
| Comp. | Combination A | | 0.05 | | |
| Ex. 52 | | | | | |
| Comp. | Combination A | | 0.1 | | |
| Ex. 53 | | | | | |
| Comp. | Combination A | | 0.3 | | |
| Ex. 54 | | | | | |
| Comp. | Combination A | | 0.5 | | |
| Ex. 55 | | | | | |
| Comp. | Combination A | | 1.0 | | |
| Ex. 56 | | | | | |
| Comp. | Combination A | | 1.5 | | |
| Ex. 57 | | | | | |
| Comp. | Combination A | | 2.5 | | |
| Ex. 58 | | | | | |
| Comp. | Combination B | | 0.05 | | |
| Ex. 59 | | | | | |
| Comp. | Combination B | | 0.1 | | |
| Ex. 60 | | | | | |
| Comp. | Combination B | | 0.3 | | |
| Ex. 61 | | | | | |
| Comp. | Combination B | | 0.5 | | |
| Ex. 62 | | | | | |
| Comp. | Combination B | | 1.0 | | |
| Ex. 63 | | | | | |
| Comp. | Combination B | | 1.5 | | |
| Ex. 64 | | | | | |
| Comp. | Combination B | | 2.5 | | |
| Ex. 65 | | | | | |
| Comp. | Combination A | | | 0.05 | |
| Ex. 66 | | | | | |
| Comp. | Combination A | | | 0.1 | |
| Ex. 67 | | | | | |
| Comp. | Combination A | | | 0.3 | |
| Ex. 68 | | | | | |
| Comp. | Combination A | | | 0.5 | |
| Ex. 69 | | | | | |
| Comp. | Combination A | | | 1.0 | |
| Ex. 70 | | | | | |
| Comp. | Combination A | | | 1.5 | |
| Ex. 71 | | | | | |
| Comp. | Combination A | | | 2.5 | |
| Ex. 72 | | | | | |
| Comp. | Combination B | | | 0.05 | |
| Ex. 73 | | | | | |
| Comp. | Combination B | | | 0.1 | |
| Ex. 74 | | | | | |
| Comp. | Combination B | | | 0.3 | |
| Ex. 75 | | | | | |
| Comp. | Combination B | | | 0.5 | |
| Ex. 76 | | | | | |
| Comp. | Combination B | | | 1.0 | |
| Ex. 77 | | | | | |
| Comp. | Combination B | | | 1.5 | |
| Ex. 78 | | | | | |
| Comp. | Combination B | | | 2.5 | |
| Ex. 79 | | | | | |
| Comp. | Combination A | | | | 0.05 |
| Ex. 80 | | | | | |
| Comp. | Combination A | | | | 0.1 |
| Ex. 81 | | | | | |
| Comp. | Combination A | | | | 0.3 |
| Ex. 82 | | | | | |
| Comp. | Combination A | | | | 0.5 |
| Ex. 83 | | | | | |
| Comp. | Combination A | | | | 1.0 |
| Ex. 84 | | | | | |
| Comp. | Combination A | | | | 1.5 |
| Ex. 85 | | | | | |
| Comp. | Combination A | | | | 2.5 |
| Ex. 86 | | | | | |
| Comp. | Combination B | | | | 0.05 |
| Ex. 87 | | | | | |
| Comp. | Combination B | | | | 0.1 |
| Ex. 88 | | | | | |
| Comp. | Combination B | | | | 0.3 |
| Ex. 89 | | | | | |
| Comp. | Combination B | | | | 0.5 |
| Ex. 90 | | | | | |
| Comp. | Combination B | | | | 1.0 |
| Ex. 91 | | | | | |
| Comp. | Combination B | | | | 1.5 |
| Ex. 92 | | | | | |
| Comp. | Combination B | | | | 2.5 |
| Ex. 93 | | | | | |
| Comp. | Combination B | 0.05 | | | |
| Ex. 94 | | | | | |
| Comp. | Combination B | 0.1 | | | |
| Ex. 95 | | | | | |
| Comp. | Combination B | 0.3 | | | |
| Ex. 96 | | | | | |
| Comp. | Combination B | 0.5 | | | |
| Ex. 97 | | | | | |
| Comp. | Combination B | 1.0 | | | |
| Ex. 98 | | | | | |
| Comp. | Combination B | 1.5 | | | |
| Ex. 99 | | | | | |
| Comp. | Combination B | 2.5 | | | |
| Ex. 100 | | | | | |

### Comparative Examples 101-458

### Preparation of a Lubricating Oil Composition Comprising Nanoporous Particles Having Different Physical Properties from Those of Examples

Lubricants were prepared by using a lubricant combination A or B as shown in Table 2. The nanoporous particles were prepared by converting silicon alkoxide into a gel type and drying the same by using a supercritical fluid such as carbon dioxide. Next, thus prepared nanoporous particles were added in the amount of Table 6 based on 100 parts by weight of the lubricant, to thereby prepare lubricating oil compositions of Comparative Examples 101 to 158.

Representatively, nano porous silica was prepared as follows. First, 50 ml of TEOS (tetraethyl ortho silicate) were mixed with 40 ml of ethanol, followed by successively adding 35 ml of ethanol, 70 ml of water, 0.275 ml of a 30% ammonia solution, and 0.2 ml of 0.5 M ammonium fluoride thereto. Here, ammonia and ammonium fluoride act as a catalyst. The resulting solution was completely mixed with gentle stirring so as to induce gelation, to thereby form an alkoxide gel. The gelation was conducted for 1 hour. After the gelation was completed, the alkoxide gel was put into an autoclave. Carbon dioxide (CO₂) was injected into the autoclave, and the temperature and pressure of the autoclave were set to above the critical point for CO₂(31° C. and 72.4 atm). The alkoxide gel was slowly released from the autoclave for 6 days. Through this process, the released particles were dried while maintaining their nanoporous structure, to thereby obtain silica aerogel (pore size: 20 nm, diameter: 6 μm).

According to the method as described above, nanoporous titanium dioxide particles (pore size: 30 nm, diameter: 8 μm) prepared by using titanium alkoxide and alcohol supercritical fluid; nanoporous alumina particles (pore size: 25 nm, diameter: 8.5 μm) prepared by forming aluminum alkoxide, converting it to a gel type and drying it with carbon dioxide supercritical fluid; and nanoporous tin dioxide particles (pore size: 40 nm, diameter: 10 μm) prepared by forming tin alkoxide, converting it to a gel type and drying it with alcohol supercritical fluid were obtained. Thus obtained nanoporous particles were added to a lubricant according to the composition rate of Table 6, to thereby prepare lubricating oil compositions.

TABLE 6

| | | Nanoporous particles (parts by weight) | | | |
|---|---|---|---|---|---|
| | | | Titanium | | Tin |
| | | Silica | dioxide | Alumina | dioxide |
| Compa- | | (pore: | (pore: | (pore: | (pore: |
| rative | | 20 nm, | 30 nm, | 25 nm, | 40 nm, |
| Ex- | | diameter: | diameter: | diameter: | diameter: |
| ample | Lubricant | 6 μm) | 8 μm) | 8.5 μm) | 10 μm) |
| Comp. | Combination A | 0.05 | | | |
| Ex. 101 | | | | | |
| Comp. | Combination A | 0.1 | | | |
| Ex. 102 | | | | | |
| Comp. | Combination A | 0.3 | | | |
| Ex. 103 | | | | | |
| Comp. | Combination A | 0.5 | | | |
| Ex. 104 | | | | | |
| Comp. | Combination A | 1.0 | | | |
| Ex. 105 | | | | | |
| Comp. | Combination A | 1.5 | | | |
| Ex. 106 | | | | | |
| Comp. | Combination A | 2.5 | | | |
| Ex. 107 | | | | | |
| Comp. | Combination B | 0.05 | | | |
| Ex. 108 | | | | | |
| Comp. | Combination B | 0.1 | | | |
| Ex. 109 | | | | | |
| Comp. | Combination B | 0.3 | | | |
| Ex. 110 | | | | | |
| Comp. | Combination B | 0.5 | | | |
| Ex. 111 | | | | | |
| Comp. | Combination B | 1.0 | | | |
| Ex. 112 | | | | | |
| Comp. | Combination B | 1.5 | | | |
| Ex. 113 | | | | | |
| Comp. | Combination B | 2.5 | | | |
| Ex. 114 | | | | | |
| Comp. | Combination A | | 0.05 | | |
| Ex. 115 | | | | | |
| Comp. | Combination A | | 0.1 | | |
| Ex. 116 | | | | | |
| Comp. | Combination A | | 0.3 | | |
| Ex. 117 | | | | | |
| Comp. | Combination A | | 0.5 | | |
| Ex. | | | | | |
| Comp. | Combination A | | 1.0 | | |
| Ex. 119 | | | | | |
| Comp. | Combination A | | 1.5 | | |
| Ex. 120 | | | | | |
| Comp. | Combination A | | 2.5 | | |
| Ex. 121 | | | | | |
| Comp. | Combination B | | 0.05 | | |
| Ex. 122 | | | | | |
| Comp. | Combination B | | 0.1 | | |
| Ex. 123 | | | | | |
| Comp. | Combination B | | 0.3 | | |
| Ex. 124 | | | | | |
| Comp. | Combination B | | 0.5 | | |
| Ex. 125 | | | | | |
| Comp. | Combination B | | 1.0 | | |
| Ex. 126 | | | | | |
| Comp. | Combination B | | 1.5 | | |
| Ex. 127 | | | | | |
| Comp. | Combination B | | 2.5 | | |
| Ex. 128 | | | | | |
| Comp. | Combination A | | | 0.05 | |
| Ex. 129 | | | | | |
| Comp. | Combination A | | | 0.1 | |
| Ex. 130 | | | | | |
| Comp. | Combination A | | | 0.3 | |
| Ex. 131 | | | | | |
| Comp. | Combination A | | | 0.5 | |
| Ex. 132 | | | | | |
| Comp. | Combination A | | | 1.0 | |
| Ex. 133 | | | | | |
| Comp. | Combination A | | | 1.5 | |
| Ex. 134 | | | | | |
| Comp. | Combination A | | | 2.5 | |
| Ex. 135 | | | | | |
| Comp. | Combination B | | | 0.05 | |
| Ex. 136 | | | | | |
| Comp. | Combination B | | | 0.1 | |
| Ex. 137 | | | | | |
| Comp. | Combination B | | | 0.3 | |
| Ex. 138 | | | | | |
| Comp. | Combination B | | | 0.5 | |
| Ex. 139 | | | | | |
| Comp. | Combination B | | | 1.0 | |
| Ex. 140 | | | | | |
| Comp. | Combination B | | | 1.5 | |
| Ex. 141 | | | | | |
| Comp. | Combination B | | | 2.5 | |
| Ex. 142 | | | | | |
| Comp. | Combination A | | | | 0.05 |
| Ex. 143 | | | | | |
| Comp. | Combination A | | | | 0.1 |
| Ex. 144 | | | | | |
| Comp. | Combination A | | | | 0.3 |
| Ex. 145 | | | | | |
| Comp. | Combination A | | | | 0.5 |
| Ex. 146 | | | | | |
| Comp. | Combination A | | | | 1.0 |
| Ex. 147 | | | | | |
| Comp. | Combination A | | | | 1.5 |
| Ex. 148 | | | | | |
| Comp. | Combination A | | | | 2.5 |
| Ex. 149 | | | | | |
| Comp. | Combination B | | | | 0.05 |
| Ex. 150 | | | | | |
| Comp. | Combination B | | | | 0.1 |
| Ex. 151 | | | | | |
| Comp. | Combination B | | | | 0.3 |
| Ex. 152 | | | | | |
| Comp. | Combination B | | | | 0.5 |
| Ex. 153 | | | | | |
| Comp. | Combination B | | | | 1.0 |
| Ex. 154 | | | | | |
| Comp. | Combination B | | | | 1.5 |
| Ex. 155 | | | | | |
| Comp. | Combination B | | | | 2.5 |
| Ex. 156 | | | | | |
| Comp. | Combination B | | | | 1.5 |
| Ex. 157 | | | | | |
| Comp. | Combination B | | | | 2.5 |
| Ex. 158 | | | | | |

### Test Example 1

### Measurement of Friction Coefficient, Traction Coefficient, Abrasion Degree, Kinematic Viscosity and Viscosity Index

The lubricating oil compositions prepared in Examples 1 to 56 and Comparative Examples 1 to 158 were subjected to measurements of a friction coefficient, a traction coefficient and a abrasion degree by using a Mini Traction Machine (MTM, PCS-instrument). At this time, the measurement of a friction coefficient, a traction coefficient and a abrasion degree was performed with an applied load of 50N, SRR 50% while varying temperature from 40 to 120° C. Thus measured average values of a friction coefficient, a traction coefficient and a abrasion degree were shown in Tables 7 and 8.

Further, kinematic viscosity as one of important physical properties of a lubricant was measured, and viscosity index representing the change in viscosity depending on temperature was measured. Viscosity was measured by using a viscometer (Cannon) at 40° C., and viscosity index was based on viscosities at 40° C. and 100° C.

TABLE 7

| | Friction | Traction | Abrasion | Viscosity | |
|---|---|---|---|---|---|
| | coefficient | coefficient | degree | (cst, | Viscosity |
| Example | (CoF) | (CoF) | (μm) | at 40° C.) | index |
| Ex. 1 | 0.06 | 0.06 | 2 | 55 | 151 |
| Ex. 2 | 0.04 | 0.05 | 1 | 55 | 152 |
| Ex. 3 | 0.04 | 0.04 | 0.6 | 55 | 151 |
| Ex. 4 | 0.04 | 0.04 | 0.2 | 54 | 151 |
| Ex. 5 | 0.05 | 0.06 | 0.2 | 55 | 151 |
| Ex. 6 | 0.05 | 0.05 | 0.1 | 53 | 153 |
| Ex. 7 | 0.07 | 0.06 | 0.05 | 55 | 151 |
| Ex. 8 | 0.06 | 0.06 | 2 | 55 | 151 |
| Ex. 9 | 0.04 | 0.05 | 1 | 55 | 152 |
| Ex. 10 | 0.04 | 0.04 | 0.6 | 55 | 151 |
| Ex. 11 | 0.04 | 0.04 | 0.2 | 54 | 151 |
| Ex. 12 | 0.05 | 0.06 | 0.2 | 55 | 151 |
| Ex. 13 | 0.05 | 0.05 | 0.1 | 53 | 153 |
| Ex. 14 | 0.07 | 0.06 | 0.05 | 55 | 151 |
| Ex. 15 | 0.06 | 0.06 | 2 | 55 | 151 |
| Ex. 16 | 0.04 | 0.05 | 1 | 55 | 152 |
| Ex. 17 | 0.04 | 0.04 | 0.6 | 55 | 151 |
| Ex. 18 | 0.04 | 0.04 | 0.2 | 54 | 151 |
| Ex. 19 | 0.05 | 0.06 | 0.2 | 55 | 151 |
| Ex. 20 | 0.05 | 0.05 | 0.1 | 53 | 153 |
| Ex. 21 | 0.07 | 0.06 | 0.05 | 55 | 151 |
| Ex. 22 | 0.06 | 0.06 | 2 | 55 | 151 |
| Ex. 23 | 0.04 | 0.05 | 1 | 55 | 152 |
| Ex. 24 | 0.04 | 0.04 | 0.6 | 55 | 151 |
| Ex. 25 | 0.04 | 0.04 | 0.2 | 54 | 151 |
| Ex. 26 | 0.05 | 0.06 | 0.2 | 55 | 151 |
| Ex. 27 | 0.05 | 0.05 | 0.1 | 53 | 153 |
| Ex. 28 | 0.07 | 0.06 | 0.05 | 55 | 151 |
| Ex. 29 | 0.06 | 0.06 | 2 | 55 | 151 |
| Ex. 30 | 0.04 | 0.05 | 1 | 55 | 152 |
| Ex. 31 | 0.04 | 0.04 | 0.6 | 55 | 151 |
| Ex. 32 | 0.04 | 0.04 | 0.2 | 54 | 151 |
| Ex. 33 | 0.05 | 0.06 | 0.2 | 55 | 151 |
| Ex. 34 | 0.05 | 0.05 | 0.1 | 53 | 153 |
| Ex. 35 | 0.07 | 0.06 | 0.05 | 55 | 151 |
| Ex. 36 | 0.06 | 0.06 | 2 | 55 | 151 |
| Ex. 37 | 0.04 | 0.05 | 1 | 55 | 152 |
| Ex. 38 | 0.04 | 0.04 | 0.6 | 55 | 151 |
| Ex. 39 | 0.04 | 0.04 | 0.2 | 54 | 151 |
| Ex. 40 | 0.05 | 0.06 | 0.2 | 55 | 151 |
| Ex. 41 | 0.05 | 0.05 | 0.1 | 53 | 153 |
| Ex. 42 | 0.07 | 0.06 | 0.05 | 55 | 151 |
| Ex. 43 | 0.06 | 0.06 | 2 | 55 | 151 |
| Ex. 44 | 0.04 | 0.05 | 1 | 55 | 152 |
| Ex. 45 | 0.04 | 0.04 | 0.6 | 55 | 151 |
| Ex. 46 | 0.04 | 0.04 | 0.2 | 54 | 151 |
| Ex. 47 | 0.05 | 0.06 | 0.2 | 55 | 151 |
| Ex. 48 | 0.05 | 0.05 | 0.1 | 53 | 153 |
| Ex. 49 | 0.07 | 0.06 | 0.05 | 55 | 151 |
| Ex. 50 | 0.06 | 0.06 | 2 | 55 | 151 |
| Ex. 51 | 0.04 | 0.05 | 1 | 55 | 152 |
| Ex. 52 | 0.04 | 0.04 | 0.6 | 55 | 151 |
| Ex. 53 | 0.04 | 0.04 | 0.2 | 54 | 151 |
| Ex. 54 | 0.05 | 0.06 | 0.2 | 55 | 151 |
| Ex. 55 | 0.05 | 0.05 | 0.1 | 53 | 153 |
| Ex. 56 | 0.07 | 0.06 | 0.05 | 55 | 151 |

TABLE 8

| | Friction | Traction | Abrasion | Viscosity | |
|---|---|---|---|---|---|
| Comparative | coefficient | coefficient | degree | (cst, | Viscosity |
| Example | (CoF) | (CoF) | (μm) | at 40° C.) | index |
| Comp. | 0.16 | 0.15 | 30 | 52 | 150 |
| Ex. 1 | | | | | |
| Comp. | 0.16 | 0.17 | 28 | 55 | 153 |
| Ex. 2 | | | | | |
| Comp. | 0.16 | 0.17 | 30 | 52 | 153 |
| Ex. 3 | | | | | |
| Comp. | 0.10 | 0.11 | 46 | 55 | 158 |
| Ex. 4 | | | | | |
| Comp. | 0.15 | 0.17 | 100 | 60 | 147 |
| Ex. 5 | | | | | |
| Comp. | 0.16 | 0.16 | 30 | 55 | 155 |
| Ex. 6 | | | | | |
| Comp. | 0.13 | 0.14 | 40 | 57 | 150 |
| Ex. 7 | | | | | |
| Comp. | 0.10 | 0.12 | 130 | 59 | 151 |
| Ex. 8 | | | | | |
| Comp. | 0.16 | 0.17 | 30 | 52 | 153 |
| Ex. 9 | | | | | |
| Comp. | 0.13 | 0.11 | 49 | 54 | 155 |
| Ex. 10 | | | | | |
| Comp. | 0.17 | 0.16 | 100 | 50 | 148 |
| Ex. 11 | | | | | |
| Comp. | 0.15 | 0.16 | 29 | 49 | 150 |
| Ex. 12 | | | | | |
| Comp. | 0.12 | 0.11 | 43 | 50 | 149 |
| Ex. 13 | | | | | |
| Comp. | 0.17 | 0.16 | 88 | 53 | 148 |
| Ex. 14 | | | | | |
| Comp. | 0.16 | 0.17 | 30 | 52 | 153 |
| Ex. 15 | | | | | |
| Comp. | 0.13 | 0.11 | 50 | 53 | 155 |
| Ex. 16 | | | | | |
| Comp. | 0.17 | 0.16 | 120 | 50 | 146 |
| Ex. 17 | | | | | |
| Comp. | 0.15 | 0.16 | 29 | 49 | 150 |
| Ex. 18 | | | | | |
| Comp. | 0.12 | 0.11 | 40 | 50 | 149 |
| Ex. 19 | | | | | |
| Comp. | 0.17 | 0.16 | 180 | 59 | 141 |
| Ex. 20 | | | | | |
| Comp. | 0.15 | 0.16 | 30 | 52 | 153 |
| Ex. 21 | | | | | |
| Comp. | 0.13 | 0.11 | 45 | 53 | 154 |
| Ex. 22 | | | | | |
| Comp. | 0.17 | 0.17 | 200 | 64 | 139 |
| Ex. 23 | | | | | |
| Comp. | 0.16 | 0.17 | 30 | 52 | 153 |
| Ex. 24 | | | | | |
| Comp. | 0.11 | 0.10 | 48 | 50 | 155 |
| Ex. 25 | | | | | |
| Comp. | 0.19 | 0.18 | 190 | 71 | 140 |
| Ex. 26 | | | | | |
| Comp. | 0.16 | 0.17 | 30 | 52 | 153 |
| Ex. 27 | | | | | |
| Comp. | 0.15 | 0.15 | 32 | 50 | 152 |
| Ex. 28 | | | | | |
| Comp. | 0.17 | 0.17 | 38 | 56 | 150 |
| Ex. 29 | | | | | |
| Comp. | 0.12 | 0.13 | 29 | 50 | 155 |
| Ex. 30 | | | | | |
| Comp. | 0.16 | 0.17 | 30 | 52 | 153 |
| Ex. 31 | | | | | |
| Comp. | 0.14 | 0.15 | 31 | 50 | 152 |
| Ex. 32 | | | | | |
| Comp. | 0.15 | 0.15 | 32 | 50 | 152 |
| Ex. 33 | | | | | |
| Comp. | 0.16 | 0.17 | 30 | 52 | 153 |
| Ex. 34 | | | | | |
| Comp. | 0.14 | 0.15 | 31 | 50 | 152 |
| Ex. 35 | | | | | |
| Comp. | 0.15 | 0.15 | 32 | 50 | 151 |
| Ex. 36 | | | | | |
| Comp. | 0.16 | 0.17 | 30 | 52 | 153 |
| Ex. 37 | | | | | |
| Comp. | 0.15 | 0.15 | 31 | 55 | 158 |
| Ex. 38 | | | | | |
| Comp. | 0.14 | 0.14 | 30 | 50 | 152 |
| Ex. 39 | | | | | |
| Comp. | 0.13 | 0.14 | 32 | 53 | 152 |
| Ex. 40 | | | | | |
| Comp. | 0.16 | 0.17 | 30 | 52 | 153 |
| Ex. 41 | | | | | |
| Comp. | 0.15 | 0.15 | 31 | 55 | 158 |
| Ex. 42 | | | | | |
| Comp. | 0.14 | 0.14 | 30 | 50 | 152 |
| Ex. 43 | | | | | |
| Comp. | 0.13 | 0.14 | 32 | 53 | 152 |
| Ex. 44 | | | | | |
| Comp. | 0.15 | 0.15 | 31 | 55 | 158 |
| Ex. 45 | | | | | |
| Comp. | 0.14 | 0.14 | 30 | 50 | 152 |
| Ex. 46 | | | | | |
| Comp. | 0.13 | 0.14 | 32 | 53 | 152 |
| Ex. 47 | | | | | |
| Comp. | 0.16 | 0.17 | 30 | 52 | 153 |
| Ex. 48 | | | | | |
| Comp. | 0.15 | 0.15 | 31 | 55 | 158 |
| Ex. 49 | | | | | |
| Comp. | 0.13 | 0.13 | 32 | 52 | 153 |
| Ex. 50 | | | | | |
| Comp. | 0.13 | 0.14 | 32 | 53 | 152 |
| Ex. 51 | | | | | |
| Comp. | 0.15 | 0.15 | 31 | 55 | 158 |
| Ex. 52 | | | | | |
| Comp. | 0.14 | 0.14 | 30 | 50 | 152 |
| Ex. 53 | | | | | |
| Comp. | 0.13 | 0.14 | 32 | 53 | 152 |
| Ex. 54 | | | | | |
| Comp. | 0.15 | 0.15 | 31 | 55 | 158 |
| Ex. 55 | | | | | |
| Comp. | 0.13 | 0.13 | 32 | 52 | 153 |
| Ex. 56 | | | | | |
| Comp. | 0.13 | 0.14 | 32 | 53 | 152 |
| Ex. 57 | | | | | |
| Comp. | 0.15 | 0.15 | 31 | 55 | 158 |
| Ex. 58 | | | | | |
| Comp. | 0.14 | 0.14 | 30 | 50 | 152 |
| Ex. 59 | | | | | |
| Comp. | 0.13 | 0.14 | 32 | 53 | 152 |
| Ex. 60 | | | | | |
| Comp. | 0.15 | 0.15 | 31 | 55 | 158 |
| Ex. 61 | | | | | |
| Comp. | 0.13 | 0.13 | 32 | 52 | 153 |
| Ex. 62 | | | | | |
| Comp. | 0.13 | 0.14 | 32 | 53 | 152 |
| Ex. 63 | | | | | |
| Comp. | 0.15 | 0.15 | 31 | 55 | 158 |
| Ex. 64 | | | | | |
| Comp. | 0.14 | 0.14 | 30 | 50 | 152 |
| Ex. 65 | | | | | |
| Comp. | 0.16 | 0.17 | 30 | 52 | 153 |
| Ex. 66 | | | | | |
| Comp. | 0.15 | 0.15 | 31 | 55 | 158 |
| Ex. 67 | | | | | |
| Comp. | 0.13 | 0.13 | 32 | 52 | 153 |
| Ex. 68 | | | | | |
| Comp. | 0.13 | 0.14 | 32 | 53 | 152 |
| Ex. 69 | | | | | |
| Comp. | 0.15 | 0.15 | 31 | 55 | 158 |
| Ex. 70 | | | | | |
| Comp. | 0.14 | 0.14 | 30 | 50 | 152 |
| Ex. 71 | | | | | |
| Comp. | 0.13 | 0.14 | 32 | 53 | 152 |
| Ex. 72 | | | | | |
| Comp. | 0.15 | 0.15 | 31 | 55 | 158 |
| Ex. 73 | | | | | |
| Comp. | 0.15 | 0.15 | 31 | 55 | 158 |
| Ex. 74 | | | | | |
| Comp. | 0.13 | 0.13 | 32 | 52 | 153 |
| Ex. 75 | | | | | |
| Comp. | 0.13 | 0.14 | 32 | 53 | 152 |
| Ex. 76 | | | | | |
| Comp. | 0.15 | 0.15 | 31 | 55 | 158 |
| Ex. 77 | | | | | |
| Comp. | 0.14 | 0.14 | 30 | 50 | 152 |
| Ex. 78 | | | | | |
| Comp. | 0.13 | 0.14 | 39 | 53 | 152 |
| Ex. 79 | | | | | |
| Comp. | 0.15 | 0.15 | 31 | 55 | 158 |
| Ex. 80 | | | | | |
| Comp. | 0.15 | 0.15 | 31 | 55 | 158 |
| Ex. 81 | | | | | |
| Comp. | 0.13 | 0.13 | 32 | 52 | 153 |
| Ex. 82 | | | | | |
| Comp. | 0.13 | 0.14 | 32 | 53 | 152 |
| Ex. 83 | | | | | |
| Comp. | 0.15 | 0.15 | 31 | 55 | 158 |
| Ex. 84 | | | | | |
| Comp. | 0.14 | 0.14 | 30 | 50 | 152 |
| Ex. 85 | | | | | |
| Comp. | 0.13 | 0.14 | 32 | 53 | 152 |
| Ex. 86 | | | | | |
| Comp. | 0.15 | 0.15 | 31 | 55 | 158 |
| Ex. 87 | | | | | |
| Comp. | 0.15 | 0.15 | 31 | 55 | 158 |
| Ex. 88 | | | | | |
| Comp. | 0.13 | 0.13 | 32 | 52 | 153 |
| Ex. 89 | | | | | |
| Comp. | 0.13 | 0.14 | 32 | 53 | 152 |
| Ex. 90 | | | | | |
| Comp. | 0.15 | 0.15 | 31 | 55 | 158 |
| Ex. 91 | | | | | |
| Comp. | 0.14 | 0.14 | 30 | 50 | 152 |
| Ex. 92 | | | | | |
| Comp. | 0.13 | 0.14 | 39 | 53 | 152 |
| Ex. 93 | | | | | |
| Comp. | 0.15 | 0.15 | 31 | 55 | 158 |
| Ex. 94 | | | | | |
| Comp. | 0.15 | 0.15 | 31 | 55 | 158 |
| Ex. 95 | | | | | |
| Comp. | 0.13 | 0.13 | 32 | 52 | 153 |
| Ex. 96 | | | | | |
| Comp. | 0.13 | 0.14 | 32 | 53 | 152 |
| Ex. 97 | | | | | |
| Comp. | 0.15 | 0.15 | 31 | 55 | 158 |
| Ex. 98 | | | | | |
| Comp. | 0.14 | 0.14 | 30 | 50 | 152 |
| Ex. 99 | | | | | |
| Comp. | 0.13 | 0.14 | 39 | 53 | 152 |
| Ex. 100 | | | | | |
| Comp. | 0.16 | 0.17 | 30 | 52 | 153 |
| Ex. 101 | | | | | |
| Comp. | 0.16 | 0.15 | 49 | 55 | 158 |
| Ex. 102 | | | | | |
| Comp. | 0.16 | 0.15 | 50 | 54 | 155 |
| Ex. 103 | | | | | |
| Comp. | 0.17 | 0.16 | 60 | 55 | 154 |
| Ex. 104 | | | | | |
| Comp. | 0.16 | 0.16 | 65 | 55 | 154 |
| Ex. 105 | | | | | |
| Comp. | 0.17 | 0.15 | 70 | 55 | 154 |
| Ex. 106 | | | | | |
| Comp. | 0.17 | 0.16 | 78 | 55 | 154 |
| Ex. 107 | | | | | |
| Comp. | 0.16 | 0.17 | 40 | 52 | 153 |
| Ex. 108 | | | | | |
| Comp. | 0.16 | 0.15 | 59 | 55 | 158 |
| Ex. 109 | | | | | |
| Comp. | 0.16 | 0.15 | 60 | 54 | 155 |
| Ex. 110 | | | | | |
| Comp. | 0.17 | 0.16 | 70 | 55 | 154 |
| Ex. 111 | | | | | |
| Comp. | 0.16 | 0.16 | 85 | 55 | 154 |
| Ex. 112 | | | | | |
| Comp. | 0.17 | 0.15 | 90 | 54 | 154 |
| Ex. 113 | | | | | |
| Comp. | 0.17 | 0.16 | 99 | 53 | 153 |
| Ex. 114 | | | | | |
| Comp. | 0.16 | 0.17 | 40 | 52 | 153 |
| Ex. 115 | | | | | |
| Comp. | 0.16 | 0.15 | 49 | 55 | 158 |
| Ex. 116 | | | | | |
| Comp. | 0.16 | 0.15 | 50 | 54 | 155 |
| Ex. 117 | | | | | |
| Comp. | 0.17 | 0.16 | 69 | 55 | 154 |
| Ex. 118 | | | | | |
| Comp. | 0.16 | 0.16 | 77 | 53 | 153 |
| Ex. 119 | | | | | |
| Comp. | 0.17 | 0.15 | 79 | 53 | 154 |
| Ex. 120 | | | | | |
| Comp. | 0.17 | 0.16 | 88 | 55 | 152 |
| Ex. 121 | | | | | |
| Comp. | 0.16 | 0.17 | 50 | 52 | 153 |
| Ex. 122 | | | | | |
| Comp. | 0.16 | 0.15 | 69 | 55 | 158 |
| Ex. 123 | | | | | |
| Comp. | 0.16 | 0.15 | 80 | 54 | 155 |
| Ex. 124 | | | | | |
| Comp. | 0.17 | 0.16 | 99 | 55 | 150 |
| Ex. 125 | | | | | |
| Comp. | 0.16 | 0.16 | 110 | 57 | 151 |
| Ex. 126 | | | | | |
| Comp. | 0.17 | 0.15 | 130 | 59 | 154 |
| Ex. 127 | | | | | |
| Comp. | 0.17 | 0.16 | 140 | 50 | 152 |
| Ex. 128 | | | | | |
| Comp. | 0.16 | 0.17 | 50 | 52 | 153 |
| Ex. 129 | | | | | |
| Comp. | 0.16 | 0.15 | 69 | 55 | 158 |
| Ex. 130 | | | | | |
| Comp. | 0.16 | 0.15 | 80 | 54 | 155 |
| Ex. 131 | | | | | |
| Comp. | 0.17 | 0.16 | 99 | 55 | 150 |
| Ex. 132 | | | | | |
| Comp. | 0.16 | 0.16 | 110 | 57 | 151 |
| Ex. 133 | | | | | |
| Comp. | 0.17 | 0.15 | 130 | 59 | 154 |
| Ex. 134 | | | | | |
| Comp. | 0.17 | 0.16 | 140 | 50 | 152 |
| Ex. 135 | | | | | |
| Comp. | 0.16 | 0.17 | 50 | 52 | 153 |
| Ex. 136 | | | | | |
| Comp. | 0.16 | 0.15 | 69 | 55 | 158 |
| Ex. 137 | | | | | |
| Comp. | 0.16 | 0.15 | 80 | 54 | 155 |
| Ex. 138 | | | | | |
| Comp. | 0.17 | 0.16 | 99 | 55 | 150 |
| Ex. 139 | | | | | |
| Comp. | 0.16 | 0.16 | 110 | 57 | 151 |
| Ex. 140 | | | | | |
| Comp. | 0.17 | 0.15 | 130 | 59 | 154 |
| Ex. 141 | | | | | |
| Comp. | 0.17 | 0.16 | 140 | 50 | 152 |
| Ex. 142 | | | | | |
| Comp. | 0.16 | 0.17 | 50 | 52 | 153 |
| Ex. 143 | | | | | |
| Comp. | 0.16 | 0.15 | 69 | 55 | 158 |
| Ex. 144 | | | | | |
| Comp. | 0.16 | 0.15 | 80 | 54 | 155 |
| Ex. 145 | | | | | |
| Comp. | 0.17 | 0.16 | 99 | 55 | 150 |
| Ex. 146 | | | | | |
| Comp. | 0.16 | 0.16 | 110 | 57 | 151 |
| Ex. 147 | | | | | |
| Comp. | 0.17 | 0.15 | 130 | 59 | 154 |
| Ex. 148 | | | | | |
| Comp. | 0.17 | 0.16 | 140 | 50 | 152 |
| Ex. 149 | | | | | |
| Comp. | 0.16 | 0.17 | 50 | 52 | 153 |
| Ex. 150 | | | | | |
| Comp. | 0.16 | 0.15 | 69 | 55 | 158 |
| Ex. 151 | | | | | |
| Comp. | 0.16 | 0.15 | 80 | 54 | 155 |
| Ex. 152 | | | | | |
| Comp. | 0.17 | 0.16 | 99 | 55 | 150 |
| Ex. 153 | | | | | |
| Comp. | 0.16 | 0.16 | 110 | 57 | 151 |
| Ex. 154 | | | | | |
| Comp. | 0.17 | 0.15 | 130 | 59 | 154 |
| Ex. 155 | | | | | |
| Comp. | 0.17 | 0.16 | 140 | 50 | 152 |
| Ex. 156 | | | | | |
| Comp. | 0.17 | 0.16 | 144 | 55 | 154 |
| Ex. 157 | | | | | |
| Comp. | 0.17 | 0.16 | 150 | 59 | 153 |
| Ex. 158 | | | | | |

Lubricants were prepared by adding various kinds of nanoporous particles in the amount as described in Examples and Comparative Examples to the combinations as shown in Tables 7 and 8, and then, their friction and abrasion reduction effects were measured. The results are shown in Tables 7 and 8.

In particular, in case of adding the excessive amount of nanoporous particles rather than the proper amount thereof as described in Comparative Examples 1 to 37, there is a problem of excessively increasing the content of inorganic substances, and thereby, reducing their friction and abrasion reduction effects when used for a long time.

It was confirmed from the above results that the friction and abrasion reduction effects of the lubricant significantly vary depending on the diameter, pore size and amount of the nanoporous particles added thereto. When the pore structure of the nanoporous particles become broken down under certain high temperature or pressure conditions, the incompletely acidified lubricant within the pocket of the structure similar to fresh oil can bring about the partial recovery of initial performance level, and in some cases, exhibit a cooling effect. Further, since their pocket has an open structure, the lubricant may be mixed therein at first. However, owing to capillary force, the lubricant may be relatively less influenced by the increase of temperature or pressure, which results in inducing the relatively low level of oxidation. Therefore, it can be expected to obtain the effect such as the supply of fresh oil and to protect abrasion more actively by acting to provide fresh oil between the particles served as a spacer at the interface where they rub each other.

Such effects on the decrease in mechanical friction and abrasion are very reliable as compared with the prior art friction reduction systems that rely on a chemical reaction mechanism and can maintain excellent friction reduction effect with relatively high reliability even under extremely variable conditions.

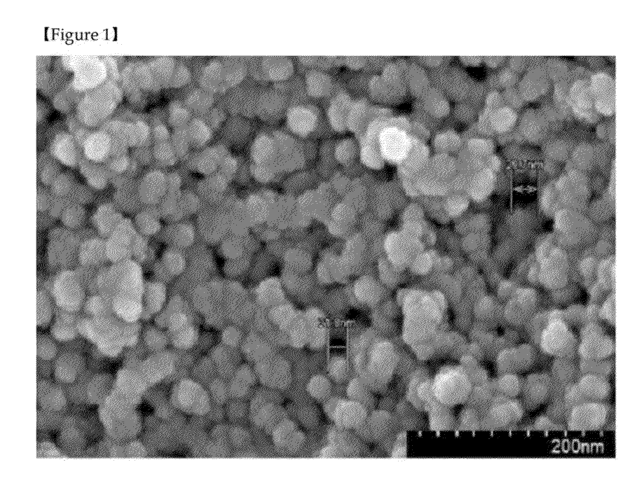

As shown in Tables 7 and 8, if the amount of the nanoporous materials is lower than 0.01 parts by weight based on 100 parts by weight of the lubricant, it is too small to exhibit the desired effects, while if that thereof exceeds 3 parts by weight based on the same, large amounts of ash is generated or friction is rather increased than decreased because of excess amounts of inorganic substances. Therefore, it is important to maintain a suitable amount of the nanoporous materials. Further, when the pore size is too big, pocket volume and surface area between the pore structures are significantly reduced, leading to the decrease in their desired effects. FIG. 1 is an enlarged photograph of representative nanoporous silica (pore size: 20 nm, diameter 400 nm) taken with an electron microscope, which shows that the nanoporous particles have a pore size of about 20 nm.

As can be seen in Examples and Comparative Examples as described above, although fundamental properties (e.g., viscosity and a viscosity index) of the lubricant may be varied depending on the amount and diameter of nanoporous particles, their influence is not so big. Further, since the amount of the nanoporous particles added thereto can be regarded as be moderate, they did not directly affect viscosity and a viscosity index of the lubricant itself. Therefore, it has been found that the influence on the fundamental properties of the lubricant such as viscosity and a viscosity index due to the addition of the nanoporous particles is not significant.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

1. A lubricating oil composition comprising:
100 parts by weight of a lubricant, and
0.01 to 3.0 parts by weight of nanoporous particles.

2. The lubricating oil composition of claim 1, wherein the nanoporous particles are selected from the group consisting of silica, titanium dioxide, alumina, tin dioxide, magnesium oxide, cerium oxide, zirconia, clay, kaolin, ceria, talc, mica, molybdenum, tungsten, tungsten disulfide, graphite, carbon nanotube, silicon nitride, boron nitride and mixtures thereof.

3. The lubricating oil composition of claim 1, wherein the nanoporous particles have an average particle size ranging from 50 nm to 5 μm.

4. The lubricating oil composition of claim 1, wherein the nanoporous particles have a pore size ranging from 0.01 nm to 100 nm.

5. The lubricating oil composition of claim 1, wherein the lubricant further comprises base oil, antioxidants, metal cleaners, corrosion inhibitors, foam inhibitors, pour point depressants, viscosity modifiers and dispersing agents.

6. The lubricating oil composition of claim 3, wherein the nanoporous particles have a pore volume of 90% or higher.
